(19) United States
(12) Patent Application Publication
(10) Pub. No.: US 2010/0103209 A1
(43) Pub. Date: Apr. 29, 2010

(54) LIQUID EJECTING APPARATUS AND METHOD OF CONTROLLING LIQUID EJECTING APPARATUS

(75) Inventor: Kenji Otokita, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/580,514

(22) Filed: Oct. 16, 2009

(30) Foreign Application Priority Data
Oct. 23, 2008 (JP) 2008-272609

(51) Int. Cl. B41J 29/38

(52) U.S. Cl. 347/10

(57) ABSTRACT

A liquid ejecting apparatus includes: nozzles which eject a liquid by an operation of a pressure generating unit; and a driving signal generating unit which generates a driving signal containing plural ejection pulses used to eject the liquid from the nozzles by operating the pressure generating unit. The liquid is ejected from the nozzles and landed on a landing target to form dots by selectively applying the ejection pulses contained in the driving signal to the pressure generating unit. A first mode where two dots are formed in one pixel area of the landing target by selecting two ejection pulses, which are formed at a first time interval, from the ejection pulses contained in the driving signal and driving the pressure generating unit or a second mode where two dots are formed in one pixel area of the landing target by selecting two ejection pulses, which are formed at a second time interval longer than the first time interval, from the ejection pulses contained in the driving signal and driving the pressure generating unit is selected depending on an ejection condition.

### BACKGROUND

1. Technical Field

The present invention relates to a liquid ejecting apparatus and a method of controlling the liquid ejecting apparatus, and more particularly to a liquid ejecting apparatus capable of controlling dots to be formed on a landing target in accordance with a supply of ejection pulses to a pressure generating unit and a method of controlling the liquid ejecting apparatus.

2. Related Art

A liquid ejecting apparatus is an apparatus which includes a liquid ejecting head capable of ejecting a liquid and ejects a variety of liquids from the liquid ejecting head. A representative example of the liquid ejecting apparatus is an image printing apparatus such as an ink jet printer (hereinafter, referred to as a printer) which performs printing by ejecting (jetting) and landing liquid-like ink onto a print sheet, which is the landing target. The liquid ejecting apparatus is not limited to the image printing apparatus, but has recently been applied to a variety of manufacturing apparatuses. For example, in a display manufacturing apparatus such as a liquid crystal display, a plasma display, an organic EL (Electro Luminescence) display, or a FED (Field Emission Display), the liquid ejecting apparatus has been used to eject a variety of liquid-like materials such as a color material or an electrode onto a pixel formation area or an electrode formation area.

The printer repeatedly generates a driving signal containing a series of plural ejection pulses (a kind of driving pulse) at a regular generation period, causes a variation in the pressure of ink in a pressure chamber by selectively applying the ejection pulses of the driving signal to a pressure generation unit such as a piezoelectric element and driving the pressure generation unit, and ejects the ink by controlling the variation in the pressure of the ink. There is known a kind of printer which performs multiple gray scale printing by changing the sizes of dots formed in a landing target such as a print sheet in accordance with the number of ejection pulses to be applied to the pressure generating unit within the same generation period (for 2003-118113). This printer generates a series of driving signals containing the plural ejection pulses with the same shape which are used to eject ink and selects the pulses from the driving signal to supply the selected pulses to the pressure generating unit.

For example, the series of driving signals is formed such that the driving signal contains the plural ejection pulses used to eject the ink within one generation period (one print period). When a large dot is formed, three ejection pulses within the print period are supplied to the pressure generating unit. When a medium dot is formed, two ejection pulses are supplied to the pressure generating unit. When a small dot is formed, one ejection pulse is supplied to the pressure generating unit. In this way, printing is performed using four gray scales, i.e., “the large dot”, “the medium dot”, “the small dot”, and “non-print”.

In a mode where an image is printed on a print sheet by forming dots with high density, for example, when an ink landing error arises, the dots may be overlapped and thus the dots may not be formed at the position where the dots should have been originally formed. For this reason, the dot may become dense. The dot density may be seen as an irregularity in an image or the like, thereby deteriorating the quality of the print image. This problem arises not only in the image printing apparatus but also in a variety of liquid ejection apparatuses.

### SUMMARY

An advantage of some aspects of the invention is that it provides a technique for improving precision in dots formed in a landing target.

According to an aspect of the invention, there is provided a liquid ejecting apparatus including: nozzles which eject a liquid by an operation of a pressure generating unit; and a driving signal generating unit which generates a driving signal containing plural ejection pulses used to eject the liquid from the nozzles by operating the pressure generating unit. The liquid is ejected from the nozzles and landed on a landing target to form dots by selectively applying the ejection pulses contained in the driving signal to the pressure generating unit. A first mode where two dots are formed in one pixel area of the landing target by selecting two ejection pulses, which are formed at a first time interval, from the ejection pulses contained in the driving signal and driving the pressure generating unit or a second mode where two dots are formed in one pixel area of the landing target by selecting two ejection pulses, which are formed at a second time interval longer than the first time interval, from the ejection pulses contained in the driving signal and driving the pressure generating unit is selected depending on an ejection condition.

With such a configuration, the first mode where two dots are formed in one pixel area of the landing target by selecting two ejection pulses, which are formed at a first time interval, from the ejection pulses contained in the driving signal and driving the pressure generating unit or the second mode where two dots are formed in one pixel area of the landing target by selecting two ejection pulses, which are formed at a second time interval longer than the first time interval, from the ejection pulses contained in the driving signal and driving the pressure generating unit is selected depending on the ejection condition. Therefore, in a situation where the dots are easily dispersed on the landing target, the first mode can be selected to prevent the dots landed on the landing target from being considerably spaced from each other. On the contrary, in a situation where the dots easily become dense on the landing target, the second mode can be selected to widen the distance between the dots landed on the landing target. In this way, it is possible to further disperse the dots landed on the landing target and prevent landing irregularity.

“The generation period” means the minimum period in which the same waveform is repeatedly formed.

In the liquid ejecting apparatus having the above configuration, upon printing a line image on the landing target, the first mode may be selected. In addition, upon printing a natural image on the landing target, the second mode may be selected.

“The line image” refers to an image, such as a photo image, which contains a shape drawn by demarcation of colors as well as a picture made mainly by lines or a character.

“The natural image” refers to an image, such as a photo image, which is drawn by expressing gray scales in more detail.

With the above configuration, when the line image is printed, the first mode can be selected to prevent the dots from being dispersed and express the contour of a figure, a character, and the like more clearly. On the other hand, in the natural image, by selecting the second mode, it is possible to further disperse the dots. It is possible to prevent irregularity from occurring in a print image. Moreover, it is possible to contribute to improving the quality of a print image.

In the liquid ejecting apparatus having the above configuration, when a distance between the nozzles and the landing target is a first distance, the first mode may be selected. In addition, when a distance between the nozzles and the landing target is a second distance shorter than the first distance, the second mode may be selected.

With such a configuration, as the distance between the nozzles and the landing target is longer, the dots are more easily dispersed on the landing target. Therefore, by selecting the first mode, it is possible to prevent the dots from being excessively dispersed. On the contrary, as the distance between the nozzles and the landing target is shorter, the dots easily become denser on the landing target. Therefore, by selecting the second mode, it is possible to further disperse the dots.

The liquid ejecting apparatus having the above configuration may further include a movement unit which moves the nozzles and the landing target relative to each other. When a movement speed during the ejection operation is a first speed, the first mode may be selected. When the movement speed during the ejection operation is a second speed slower than the first speed, the second mode may be selected.

With such a configuration, as the movement speed (which is a relative speed of the nozzles and the landing target) is faster during the ejection operation, the dots are dispersed more easily on the landing target. In this case, by selecting the first mode, it is possible to prevent the dots from being excessively dispersed. On the contrary, as the movement speed during the ejection operation is slower, the dots become denser on the landing target. Therefore, by selecting the second mode, it is possible to further disperse the dots.

In the liquid ejecting apparatus having the above configuration, when the landing target has a first permeability property for the liquid, the first mode may be selected. When the landing target has a second permeability property lower than the first permeability property for the liquid, the second mode may be selected.

“The first permeability property” refers to a property where most of the liquid (solvent) permeates the landing target when the liquid is landed on a print sheet or the like.

“The second permeability property” refers to a property where the landed liquid (solvent) permeates the print sheet or the like less than “the first permeability property”.

With such a configuration, in a case of the landing target having the first permeability property where the liquid easily permeates the landing target, the landed liquid is easily absorbed and spreads. Therefore, in this case, by selecting the first mode, it is possible to prevent the dots from excessively spreading. On the contrary, in a case of the landing target having the second permeability property where the liquid penetrates the landing target less, the dots easily become dense. In this case, by selecting the second mode, it is possible to further disperse the dots.

According to another aspect of the invention, there is provided a liquid ejecting apparatus including: nozzles which eject a liquid by an operation of a pressure generating unit; and a driving signal generating unit which generates a driving signal containing plural ejection pulses used to eject the liquid from the nozzles at a regular generation period by operating the pressure generating unit. The liquid is ejected from the nozzles and landed on a landing target to form dots by selectively applying the ejection pulses contained in the driving signal to the pressure generating unit. A first mode where two dots are formed on the landing target by selecting two ejection pulses, which are formed at a first time interval, from the ejection pulses of the same generation period and driving the pressure generating unit or a second mode where two dots are formed on the landing target by selecting two ejection pulses, which are formed at a second time interval longer than the first time interval, from the ejection pulses of the same generation period and driving the pressure generating unit is selected depending on an ejection condition.

According to still another aspect of the invention, there is provided a liquid ejecting apparatus including: nozzles which eject a liquid by an operation of a pressure generating unit; and a driving signal generating unit which generates a driving signal containing plural ejection pulses used to eject the liquid from the nozzles by operating the pressure generating unit. The liquid is ejected from the nozzles and landed on a landing target to form dots by selectively applying the ejection pulses contained in the driving signal to the pressure generating unit. First nozzles eject a first liquid on the landing target by selecting two ejection pulses, which are formed at a first time interval, from the ejection pulses of the same generation period and driving the pressure generating unit. Second nozzles different from the first nozzles eject a second liquid different from the first liquid on the landing target by selecting two ejection pulses, which are formed at a second time interval longer than the first time interval, from the ejection pulses of the same generation period and driving the pressure generating unit.

With such a configuration, since the first nozzles eject the first liquid on the landing target by selecting two ejection pulses, which are formed at the first time interval, from the ejection pulses of the same generation period and driving the pressure generating unit. The second nozzles different from the first nozzles eject the second liquid different from the first liquid on the landing target by selecting two ejection pulses, which are formed at the second time interval longer than the first time interval, from the ejection pulses of the same generation period and driving the pressure generating unit, it is possible to ensure the ejection property of the landed dots in accordance with the kinds of liquids. For example, in the nozzles ejecting the first liquid of which the dots are easily dispersed on the landing target, two ejection pulses which are formed at the first time interval can be used to prevent the dots landed on the landing target from being excessively spaced from each other. In addition, in the nozzles ejecting the second liquid of which the dots easily become dense on the landing target, two ejection pulses which are formed at the second time interval can be used to widen the distance between the dots landed on the landing target. In this way, it is possible to further disperse the dots landed on the landing target and prevent the landing irregularity.

### BRIEF DESCRIPTION OF THE DRAWINGS

The invention will be described with reference to the accompanying drawings, wherein like numbers reference like elements.

FIG. 1 is a perspective view illustrating the configuration of a printer.

FIG. 2 is a sectional view illustrating the configuration of the main elements of a printing head.

FIG. 3 is a block diagram illustrating the electric configuration of the printer.

FIG. 4 is a diagram illustrating the waveform configuration of ejection pulses contained in a driving signal.

FIGS. 5A and 5B are schematic views for explaining a positional relation between unit dots which form a medium dot.

### DESCRIPTION OF EXEMPLARY EMBODIMENTS

Hereinafter, an exemplary embodiment of the invention will be described with reference to the accompanying drawings. In the embodiment described below, a variety of limitations is put on a specific example suitable for the invention, but the invention is not limited thereto, as long as the description limiting the invention is not made in the following description. Hereinafter, an ink jet printing apparatus (hereinafter, referred to as a printer) is used as an example of a liquid ejecting apparatus according to the invention.

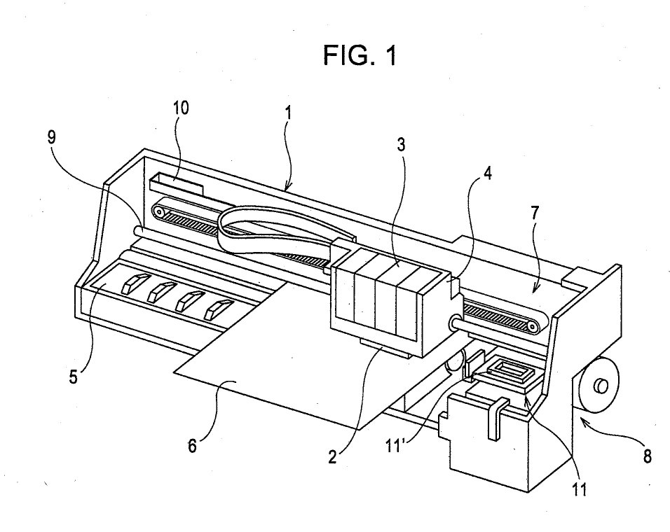

FIG. 1 is a perspective view illustrating the configuration of a printer 1. The printer 1 is mounted with a printing head 2, which is a kind of a liquid ejecting head. The printer 1 includes a carriage 4 on which ink cartridges 3 are detachably mounted, a platen 5 which is disposed below the printing head 2, a carriage moving mechanism 7 (which is a kind of movement unit) which moves the carriage 4 mounted with the printing head 2 in a sheet width direction of a print sheet 6 (which is a kind of print medium or a kind of landing target), and a sheet transporting mechanism 8 which transports the print sheet 6 in a sheet transporting direction which is a direction perpendicular to a sheet surface direction. Here, the sheet surface direction is a main scanning direction (head scanning direction) and the sheet transporting direction is a sub-scanning direction (that is, a direction perpendicular to the head scanning direction). The ink cartridge 3 may be a cartridge which is mounted on the carriage 4 or which is mounted on a side of a casing of the printer 1 to supply a liquid to the printing head 2 through an ink supply tube.

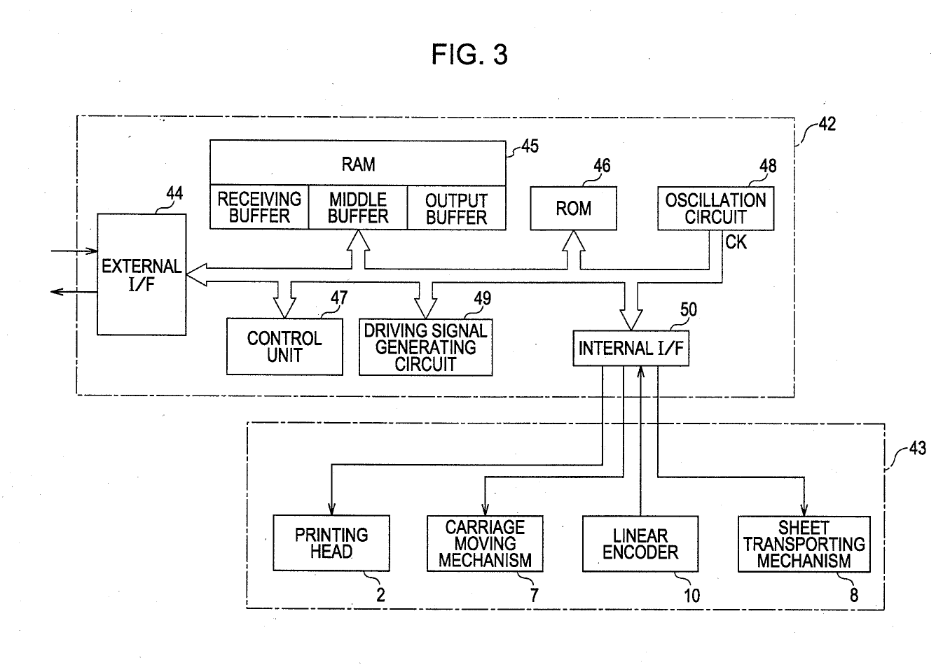

The carriage 4 is mounted so as to be shaft-supported by a guide rod 9 disposed in the main scanning direction and is configured to move along the guide rod 9 in the main scanning direction by the operation of the carriage moving mechanism 7. The position of the carriage 4 moving in the main scanning direction is detected by a linear encoder 10. A signal obtained by the detection is sent as position information to a printer controller 42 (see FIG. 3). With such a configuration, the printer controller 42 is capable of controlling a print operation (an ejection operation) or the like performed by the printing head 2, while recognizing the scanning position of the carriage 4 (the printing head 2) on the basis of the position information from the linear encoder 10.

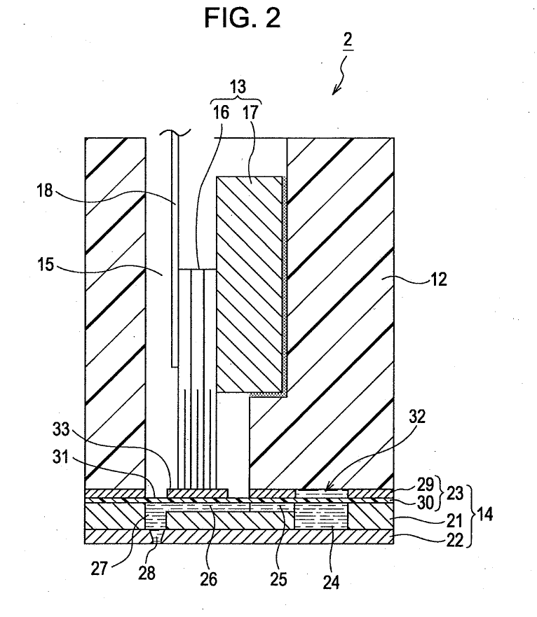

A home position serving as a scanning start point of the printing head 2 is configured outside the platen 5 within a movement range of the printing head 2. A capping mechanism 11 is disposed at the home position. In the capping mechanism 11, a cap member 11′ seals a nozzle formation surface of the printing head 2 to prevent the solvent of ink from evaporating from nozzles 28 (see FIG. 2). The capping mechanism 11 is used for a cleaning operation of applying a negative pressure to the nozzle formation surface which is in a sealed state and forcibly sucking and discharging the ink from the nozzles 28.

FIG. 2 is a sectional view illustrating the configuration of the main elements of the printing head 2. The printing head 2 includes a head case 12, an actuator unit 13 accommodated in the head case 12, and a passage unit 14 joined on the bottom surface (front end surface) of the head case 12. The head case 12 is made of epoxy-based resin, for example. An accommodation space 15 for accommodating the actuator unit 13 is formed in the head case 12. The actuator unit 13 includes a plurality of piezoelectric elements 16 (which are an example of a pressure generating unit according to the invention) separated in a pectinate shape and a fixing plate 17 to which the piezoelectric elements 16 are joined. A flexible cable 18 is connected to each of the piezoelectric elements 16 of the actuator unit 13, and thus a driving signal from a driving signal generating circuit 49 (see FIG. 3) is supplied to each piezoelectric element 16 through the flexible cable 18. The piezoelectric element 16 according to this embodiment is a so-called vertical vibration mode piezoelectric element which is displaced in a direction perpendicular to an electric field direction. When the driving signal is supplied, the piezoelectric element 16 is displaced (expanded or contracted) in a direction perpendicular to a lamination direction in which a piezoelectric body and an electrode are laminated.

The passage unit 14 is formed by joining a nozzle plate 22 and a vibration plate 23 (sealing plate) to one surface and the other surface of a passage forming board 21, respectively, to incorporate them. As shown in FIG. 2, a reservoir 24 (common liquid chamber), an ink supply port 25, a pressure chamber 26, a nozzle communicating port 27, and the nozzles 28 form a series of ink passage (liquid passage).

The nozzle plate 22 is a thin metal plate formed by punching the plurality of nozzles 28 in a row shape. In this embodiment, the nozzle plate 22 is formed of a stainless plate and a plurality of rows (nozzle rows) of the nozzles 28 is formed therein. One nozzle row is constituted by 360 nozzles 28. Each nozzle 28 has a nozzle density of 360 dpi to correspond to the pressure chamber 26.

The passage forming board 21 placed between the nozzle plate 22 and the vibration plate 23 is a plate-shaped member in which the ink passage is formed, that is, an opening serving as the reservoir 24, a groove serving as the ink supply port 25, and a space serving as the pressure chamber 26 are partitioned. The passage forming board 21 is produced by performing anisotropic etching on a silicon wafer, for example. The vibration plate 23 is a complex plate formed by laminating a PPS (polyphenylene sulfide) resin film serving as a thin elastic film 30 on the surface of a support plate 29 made of metal such as stainless steel, for example. In the vibration plate 23, there is formed a diaphragm 31 which is deformed in accordance with the expansion and contraction drive of the piezoelectric elements 16 to cause a pressure variation to ink (which is an example of a liquid) of the pressure chamber 26. The diaphragm 31 is formed only of the thin elastic film 30 by removing the support plate 29 by etching in a state where a portion connected to the front end surfaces of the piezoelectric elements 16 remains as an island section 33. In the vibration plate 23, there is formed a compliance section 32 partitioning a part of the reservoir 24 by sealing one opening surface of the opening of the passage forming board 21. The compliance section 32 is formed only of the thin elastic film 30 by removing the support plate 29 in an area corresponding to the reservoir 24 by etching. Moreover, the compliance section 32 functions as a damper reducing the pressure variation in the ink in the reservoir 24 upon driving the piezoelectric elements 16.

FIG. 3 is a block diagram illustrating the electric configuration of the printer. The printer 1 according to this embodiment includes the printer controller 42 and a print engine 43. The printer controller 42 includes an external interface (external I/F) 44 which receives input of print data or the like from an external apparatus such as a host computer, a RAM 45 which is used as a work memory for temporarily storing a variety of data or the like, a ROM 46 which stores a control program, font data, a graphic function, or the like used to process the variety of data, a control unit 47 which controls units, an oscillation circuit 48 which generates a clock signal, a driving signal generating circuit 49 which generates the driving signal to be supplied to the printing head 2, and an internal interface (internal I/F) 50 which outputs ejection data (gray scale data) obtained by developing the print data for every dot or the driving signal to the printing head 2.

The control unit 47 controls units as a whole on the basis of the control program stored in the ROM 46 and also converts the print data received from an external apparatus via the external I/F 44 into the gray scale data (dot pattern data) to be used in the printing head 2. Specifically, the control unit 47 reads the print data temporarily stored in a receiving buffer of the RAM 45, converts the read print data into intermediate code data, and stores the intermediate code data in a middle buffer of the RAM 45. The control unit 47 converts the converted intermediate code data into the gray scale data corresponding to a dot pattern with reference to the font data, the graphic function, and the like, and then stores the converted gray scale data in an output buffer of the RAM 45. When recordable one-line gray scale data is obtained by performing one-time main scanning of the printing head 2, the control unit 47 outputs the one-line gray scale data stored in the output buffer to the printing head 2 via the internal I/F 50.

The print engine 43 includes the printing head 2, the carriage moving mechanism 7, the sheet transporting mechanism 8, and the linear encoder 10. The carriage moving mechanism 7 includes a carriage mounted with the printing head 2 and a driving motor (for example, a DC motor) which drives the carriage through a timing belt or the like. The carriage moving mechanism 7 moves the printing head 2 in the main scanning direction. The sheet transporting mechanism 8 includes a sheet transporting motor and a sheet transporting roller and sends the print sheet 6 one by one to perform sub-scanning. The linear encoder 10 outputs as position information of the main scanning direction encoder pulses in accordance with the scanning position of the printing head 2 mounted on the carriage 4 to the control unit 47 through the internal I/F 50. In this way, the control unit 47 can grasp the position of the printing head 2 in the main scanning direction on the basis of the encoder pulses received from the linear encoder 10.

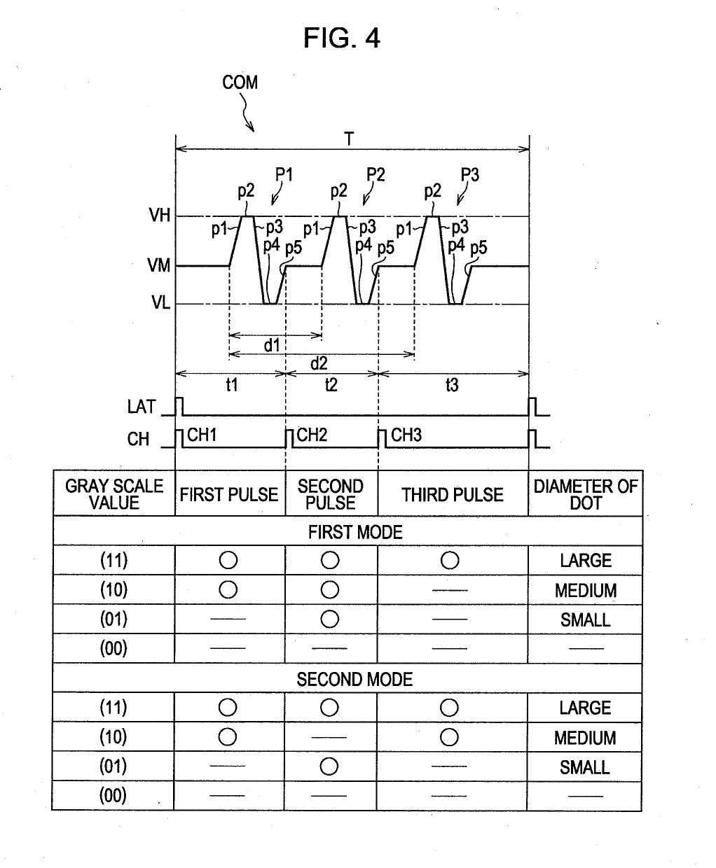

The driving signal generating circuit 49 generates a series of driving signals containing a plurality of ejection pulses (ejection waveforms). The ejection pulse is a pulse used to eject the ink from the nozzles 28 by driving the piezoelectric elements 16 in an expansion and contraction manner. A driving signal COM exemplified in FIG. 4 contains three ejection pulses (a first ejection pulse P1, a second ejection pulse P2, and a third ejection pulse P3) at one print period T (regular generation period). The driving signal generating circuit 49 repeatedly generates the driving signal COM at the print period T. The first ejection pulse P1 to the third ejection pulse P3 are all formed of a signal of the same waveform and contain an expansion component p1 which increases a potential from a middle potential VM to the highest potential VH at a regular gradient of the degree at which the ink is not ejected, an expansion holding component p2 which holds the highest potential VH for a predetermined time, an ejection component p3 which decreases the potential from the highest potential VH to the lowest potential VL at a steep gradient, a contraction hold component p4 which holds the lowest potential VL for a predetermined time, and a vibration control component p5 which returns the potential to the middle potential VM from the lowest potential VL.

Whenever the first ejection pulse P1 to the third ejection pulse P3 are supplied to the piezoelectric elements 16, a regular amount of ink is ejected from the nozzles 28. In addition, by varying the number of ejection pulses to be supplied at one print period T, the sizes of the dots to be printed on one pixel area (an imaginary area on the print sheet 6) can be made different. In this embodiment, it is possible to switch between the two first and second modes depending on a situation. In the first mode, in a case of gray scale data (11), the ink ejection operation is performed consecutively three times at one print period T by supplying the three ejection pulses P1 to P3 sequentially to the piezoelectric elements 16 at one print period T. In this way, ink is landed onto the print sheet 6 to form three dots (which are hereinafter referred to as unit dots and kinds of dots according to the invention). A large dot is formed by the unit dots. In a case of gray scale data (10), the ink ejection operation is performed twice at one print period T by sequentially supplying the total of two ejection pulses, i.e., the first ejection pulse P1 and the second ejection pulse P2 adjacent to each other to the piezoelectric elements 16 at one print period T. In this way, two unit dots are formed on the print sheet 6 and a medium dot is formed by the two unit dots. In a case of gray scale data (01), the ink ejection operation is performed only once at one print period T by supplying only the second ejection pulse P2 to the piezoelectric elements 16 at one print period T. In this way, one unit dot is formed on the print sheet 6 and becomes a small dot. In a case of gray scale data (00), no dot is formed on the print sheet 6, since the ejection pulse is not supplied to the piezoelectric elements 16.

In this way, the driving signal having one print period T as the minimum unit is repeatedly generated according to this embodiment. By supplying one gray scale data corresponding to the driving signal of one print period T, the dots are formed in one pixel area.

In the second mode, the large dot and the small dot are the same as those of the first mode in the printing, but the medium dot is different from that of the first mode in the printing. Specifically, in the second mode, in the case of the gray scale data (10), the ink ejection operation is performed twice at one print period T by sequentially supplying the first ejection pulse P1 and the third ejection pulse P3 to the piezoelectric elements 16 at one print period T. In this way, two unit dots spaced from each other are formed on the print sheet 6. A medium dot is formed by the two unit dots.

As shown in FIG. 4, the first ejection pulse P1 and the second ejection pulse P2 are formed at a time interval d1 and the first ejection pulse P1 and the third ejection pulse P3 are formed at a time interval d2 which is longer than the time interval d1. Accordingly, even when ink is ejected twice at one print period T to form the medium dot, the first mode is different from the second mode in a distance between two unit dots which form the medium dot.

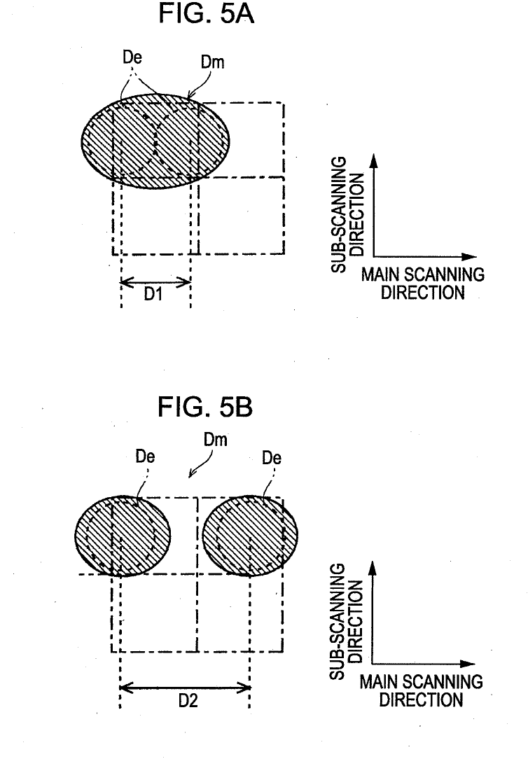

FIGS. 5A and 5B are schematic views for explaining a positional relation between the unit dots which form the medium dot. FIG. 5A shows the first mode and FIG. 5B shows the second mode. In FIGS. 5A and 5B, a pixel area is schematically indicated by four rectangular frames. When the medium dot is formed under the same conditions (various conditions such as kind of print medium, kind of ink, movement speed of the printing head 2, distance between the nozzles 28 and the print medium, and ambient temperature), as shown in FIGS. 5A and 5B, a distance D2 between unit dots De is larger than a distance D1 between the unit dots De in the medium dot formed in the first mode. In this example, whereas most of the two unit dots are formed in the same range in the first mode, one of the two unit dots De (the right unit dot) is formed in the adjacent frame in the second mode. When a case where the unit dots are incorporated to make the unit dots close to each other and thus one dot is formed in the first mode of FIG. 5A is compared to a case where the unit dots are spaced from each other to form independent dots in the second mode, an ink-covered area on the landing target is larger in the latter case than in the former case. Accordingly, in terms of the efficiency of the ink-covered area, the case where a predetermined area on the landing target is covered with ink by forming several medium dots in the second mode is better than the case where the unit dots are incorporated to make the unit dots close to each other and thus one dot is formed in the first mode.

In a situation where it is easy to disperse the unit dots on the landing target or a situation where it is difficult to permeate and absorb the unit dots into the landing target, the unit dots are hardly incorporated to form one dot. Therefore, by selecting the first mode, it is possible to prevent the unit dots landed on the landing target from being spaced from each other. However, in a situation where the unit dots are easily close to each other on the landing target or a situation where the unit dots are easily permeated and absorbed into the landing target, the second mode can be selected. Then, it is possible to prevent the unit dots from being incorporated into one dot by spacing the distance between the unit dots landed on the landing target. In this way, even when the unit dots to be landed on the landing target are dispersed and a landing error occurs, it is possible to prevent the unit dots from being incorporated into one dot so as not to become dense. As a result, it is possible to contribute to improving the quality of a print image.

The first and second modes can be switched depending on various situations. For example, the first mode can be selected, when a line image is printed on the landing target (the print sheet 6). The second mode can be selected, when a natural image is printed on the landing target. Therefore, by selecting the first mode when the line image is printed, it is possible to prevent the dots (the unit dots) from dispersing. Therefore, the contour of a figure, a character, or the like can be clearly recognized. On the other hand, by selecting the second mode when the natural image is printed, it is possible to disperse the dots. Therefore, it is possible to prevent irregularity in the colors of the print image and thus to contribute to improving the quality of the print image.

The modes may be switched depending on a distance (hereinafter, also referred to as a gap) between the nozzles 28 of the printing head 2 and the landing target. Specifically, in a case of a first distance where the gap is relatively longer, the first mode can be selected. In a case of a second distance where the gap is shorter than the first distance, the second mode can be selected. That is, as the distance between the nozzles of the liquid ejecting head and the landing target is longer, that is, as an ink flying distance is longer, non-uniformity in a landing position becomes greater due to flying speed imbalance between the ejected ink droplets or air resistance. Therefore, the dots are easily dispersed on the landing target. In this case, by selecting the first mode, it is possible to prevent the dots from being excessively dispersed. On the other hand, as the gap is shorter, the dots easily become dense on the landing target. Therefore, in this case, by selecting the second mode, it is possible to further disperse the dots.

As a scanning speed (a movement speed during the ejection operation) of the printing head 2 is faster, the distance between the dots becomes larger at the same time interval of the dot ejection. Therefore, the modes can be switched depending on the scanning speed. Specifically, in a case of a first speed where the scanning speed of the printing head 2 is relatively fast, the first mode is selected. In a case of a second speed where the scanning speed of the printing head 2 is slower than the first speed, the second mode is selected. That is, as the scanning speed of the printing head 2 is faster, the dots become dispersed more easily on the landing target. Therefore, in this case, by selecting the first mode, it is possible to prevent the dots from being excessively dispersed. However, as the scanning speed of the printing head 2 is slower, the dots more easily become dense on the landing target. Therefore, in this case, by selecting the second mode, it is possible to further disperse the dots.

The modes may be switched depending on the kind of landing target. For example, when the print sheet 6 of the landing target is a sheet such as a normal sheet which has a high permeability property of ink (has a first permeability property), the first mode can be selected. On the contrary, when the landing target is a sheet such as an OHP which has a low permeability property of ink (has a second permeability property), the second mode can be selected. The landed ink (dots) is absorbed and easily spread in the landing target having the high permeability property of ink. Therefore, in this case, by selecting the first mode, it is possible to prevent the dots from spreading excessively. However, the landed ink is rarely absorbed and the dots easily become dense in the landing target having the low permeability property of ink. Therefore, in this case, by selecting the second mode, it is possible to further disperse the dots.

According to another embodiment, in a printer capable of ejecting plural kinds (colors) of ink, the medium dot may be distinguished and used on the basis of the degree to which the dots can easily be dispersed on another landing target depending on the kinds of ink. For example, the nozzles 28 (corresponding to the first nozzles) ejecting first ink (a kind of first liquid) having a relatively low viscosity print the medium dots on the landing target by selecting the first ejection pulse P1 and the second ejection pulse P2, which are formed at the first time interval d1, from the ejection pulses at the same print period T and driving the piezoelectric elements 16. In addition, the nozzles 28 (corresponding to second nozzles) ejecting second ink (a kind of second liquid) having a relatively high viscosity print the medium dots on the landing target by selecting the first ejection pulse P1 and the third ejection pulse P3, which are formed at the second time interval d2, from the ejection pulses at the same print period T and driving the piezoelectric elements 16. Here, as for the ink having the high viscosity, the vibration remaining after the ejection is rarely converged. Therefore, since the remaining vibration caused by the initial ejection has an influence upon second ejection, irregularity in the dots formed by the second ejection is increased. However, in the above configuration, the dispersion property of the dots landed in accordance with the kind of ink can be ensured. That is, in the first nozzles 28 ejecting the first ink of which the dots are easily dispersed on the landing target, it is possible to prevent the distance between the dots (the unit dots) landed on the landing target from being considerably spaced from each other by using the first ejection pulse P1 and the second ejection pulse P2. In addition, in the second nozzles 28 ejecting the second ink of the dots easily become dense on the landing target, it is possible to widen the distance between the dots landed on the landing target by using the first ejection pulse P1 and the third ejection pulse P3. In this way, it is possible to further disperse the dots landed on the landing target and prevent landing irregularity.

In a configuration where the nozzle rows (nozzle groups) are allocated in accordance with the kinds of ink, the medium dot is appropriately used in each nozzle row.

Since the viscosity of the ink depends on the temperature of the environment of the head (ambient temperature), the medium dots may be switched depending on this temperature. For example, when the ambient temperature is higher than a reference temperature (for example, 25° C.), the viscosity of the ink decreases, and thus the flying speed of the ink becomes faster. In this case, by selecting the first ejection pulse P1 and the third ejection pulse P3 from the ejection pulses at the same print period T and driving the piezoelectric elements 16, the medium dot is printed on the landing target. On the contrary, when the ambient temperature is lower than the reference temperature (for example, 25° C.), the viscosity of the ink increases, and thus the flying speed of the ink becomes slower. In this case, by selecting the first ejection pulse P1 and the second ejection pulse P2 from the ejection pulses at the same print period T and driving the piezoelectric elements 16, the medium dot is printed on the landing target.

The invention is not limited to the above-described embodiment, but may be modified in various forms on the basis of the description of the claims.

For example, when the relative movement of the nozzles and the landing target is accelerated, the first mode may be selected. On the contrary, when the relative movement of the nozzles and the landing target is decelerated, the second mode may be selected.

In the above-described embodiment, the driving signal COM contains the three ejection pulses P1 to P3 and two pulses are selected from the ejection pulses. However, the invention is not limited thereto. For example, the invention is applicable to a configuration where the driving signal COM contains four or more ejection pulses and three or more pulses may be selected from the ejection pulses. In multiple gray scale printing performed by using a plurality of ejection pulses of the driving signal COM, two pulses of the ejection pulses used in at least one gray scale may be formed at the time interval d2 longer than time interval d1 in accordance with the modes.

The waveform of the ejection pulses is not limited to the waveform exemplified in the above-described embodiment, but an ejection pulse of an arbitrary shape may be used.

The modes may be distinguished and used in accordance with the degree to which the ink can easily permeate the landing target.

The invention is applicable to a liquid ejection apparatus as well as the above-described printer, as long as the liquid ejection apparatus has a configuration where a liquid is landed on a landing target while a liquid ejection head and the landing target are moved relative to each other. For example, the invention is applicable to a display manufacturing apparatus, an electrode manufacturing apparatus, a chip manufacturing apparatus, etc.

In the above-described embodiment, the nozzles 28 are formed in the printing head 2. However, the invention is not limited thereto. For example, the invention is applicable to a liquid ejecting apparatus in which nozzles for ejecting a liquid are formed.

What is claimed is:

1. A liquid ejecting apparatus comprising:
nozzles which eject a liquid by an operation of a pressure generating unit; and
a driving signal generating unit which generates a driving signal containing plural ejection pulses used to eject the liquid from the nozzles by operating the pressure generating unit,
wherein the liquid is ejected from the nozzles and landed on a landing target to form dots by selectively applying the ejection pulses contained in the driving signal to the pressure generating unit, and
wherein a first mode where two dots are formed in one pixel area of the landing target by selecting two ejection pulses, which are formed at a first time interval, from the ejection pulses contained in the driving signal and driving the pressure generating unit or a second mode where two dots are formed in one pixel area of the landing target by selecting two ejection pulses, which are formed at a second time interval longer than the first time interval, from the ejection pulses contained in the driving signal and driving the pressure generating unit is selected depending on an ejection condition.

2. The liquid ejecting apparatus according to claim 1,
wherein upon printing a line image on the landing target, the first mode is selected, and
wherein upon printing a natural image on the landing target, the second mode is selected.

3. The liquid ejecting apparatus according to claim 1,
wherein when a distance between the nozzles and the landing target is a first distance, the first mode is selected, and
wherein when a distance between the nozzles and the landing target is a second distance shorter than the first distance, the second mode is selected.

4. The liquid ejecting apparatus according to claim 1, further comprising:
a movement unit which moves the nozzles and the landing target relative to each other,
wherein when a movement speed during the ejection operation is a first speed, the first mode is selected, and
wherein when the movement speed during the ejection operation is a second speed slower than the first speed, the second mode is selected.

5. The liquid ejecting apparatus according to claim 1,
wherein when the landing target has a first permeability property for the liquid, the first mode is selected, and
wherein when the landing target has a second permeability property lower than the first permeability property for the liquid, the second mode is selected.

6. A liquid ejecting apparatus comprising:
nozzles which eject a liquid by an operation of a pressure generating unit; and
a driving signal generating unit which generates a driving signal containing plural ejection pulses used to eject the liquid from the nozzles at a regular generation period by operating the pressure generating unit,
wherein the liquid is ejected from the nozzles and landed on a landing target to form dots by selectively applying the ejection pulses contained in the driving signal to the pressure generating unit, and
wherein a first mode where two dots are formed on the landing target by selecting two ejection pulses, which are formed at a first time interval, from the ejection pulses of the same generation period and driving the pressure generating unit or a second mode where two dots are formed on the landing target by selecting two ejection pulses, which are formed at a second time interval longer than the first time interval, from the ejection pulses of the same generation period and driving the pressure generating unit is selected depending on an ejection condition.

7. A liquid ejecting apparatus comprising:
nozzles which eject a liquid by an operation of a pressure generating unit; and
a driving signal generating unit which generates a driving signal containing plural ejection pulses used to eject the liquid from the nozzles by operating the pressure generating unit,
wherein the liquid is ejected from the nozzles and landed on a landing target to form dots by selectively applying the ejection pulses contained in the driving signal to the pressure generating unit,
wherein first nozzles eject a first liquid on the landing target by selecting two ejection pulses, which are formed at a first time interval, from the ejection pulses of the same generation period and driving the pressure generating unit, and
wherein second nozzles different from the first nozzles eject a second liquid different from the first liquid on the landing target by selecting two ejection pulses, which are formed at a second time interval longer than the first time interval, from the ejection pulses of the same period and driving the pressure generating unit.
